(19) United States
(12) Patent Application Publication
(10) Pub. No.: US 2023/0189723 A1
(43) Pub. Date: Jun. 22, 2023

(54) DETERRENT BARRIER FOR THE PROTECCION OF DEVEOPING FRUITS AND VEGETABLES HANGING FROM PLANTS AGAINST BIRDS, RODENTS SQUIREELS MANY INSECTS AND OTHER PESTS

(71) Applicant: EDWIN A. CORDERO, Miami, FL (US)

(72) Inventor: EDWIN A. CORDERO, Miami, FL (US)

(21) Appl. No.: 17/645,528

(22) Filed: Dec. 22, 2021

(51) Int. Cl. A01G 13/02; A01G 13/10

(52) U.S. Cl. CPC A01G 13/0237; A01G 13/10; A01G 2013/006

(57) ABSTRACT

The device would be a spherical-shaped case made of lightweight, clear plastic. It would consist of two-pieces with hinges on the upper, middle and lower back area that would enable the user to easily clamp the device around each developing fruit or vegetable attached to a plant, while it is in the early stage of growth. The device would have a stem opening made of soft rubber split in 2 halves and a protective foam cushion, also split in 2 halves, on one end that would allow it to be attached safely and securely over the stem without crushing it. The plastic case would contain a plurality of ventilation apertures. The device could be injection molded from clear plastic, such as Polyvinyl chloride (PVC). The stem entry can be made of flexible weather resistant rubber and the foam insert could be molded from polyurethane foam or foam rubber.

### BACKGROUND

### 1. Field of Invention

The invention relates to a deterrent barrier for the protection of developing fruits and vegetables hanging from the plant against birds, rodents, squirrels, many insects and other pests. Specifically, the invention refers to protection encasing that can be mounted directly on the stems of growing fruits or vegetables from being damaged by squirrels and other climbing and flying animals and insects that can cause great damage to developing and mature fruit or vegetables while hanging in the plant, but not ready for harvesting.

### 2. Description of Prior Art

Relevant prior art reveled as disclosed below shows that while the broad concept and function of my invention may not be new, I believe that my invention discloses certain novel structural and/or functional features which are neither shown nor made obvious by any of the patent documents discovered during the search, whether these documents are considered individually or in combination with each other.

### Relevant Prior Art (U.S. & Foreign Countries)

The patent documents listed below, copies of which are provided herewith, are considered relevant to my invention. They are not arranged in any particular order and a brief explanation of why each document was chosen is provided.

U.S. Patent Application 2020/0113139 discloses a light-transmissive fruit protection case that is installed over a cluster of fruit on a tree.

U.S. Patent Application 2019/0159408 discloses a plant protection device in the form of two substantially hemispherical portions that are used to enclosed a section of a plant.

U.S. Pat. No. 6,505,438 discloses a protective cage for growing fruit on a tree.

U.S. Pat. No. 5,974,729 discloses a fruit or vegetable protection device in the form of a spherical molded plastic housing with a plurality of ventilation holes which encloses a fruit hanging from a tree.

U.S. Pat. No. 6,612, 440 discloses a banana protective device that is used for storing and transporting banana.

U.S. Pat. No. 5,535,543 discloses a thermally protective covering for fruits or vegetables that are still maturing on a parent plant.

U.S. Pat. No. 4,187,639 discloses a mold that is placed over a maturing fruit to form the fruit into a desired shape.

U.S. Pat. No. 777,898 illustrates an ornamental design for a pear-shaped potpourri cage.

Foreign Patent Document GB2471199A discloses a fruit protection device that encircles fruit or vegetables that are growing on a plant.

### SUMMARY OF THE INVENTION

The device would be a spherical-shaped case made of lightweight, clear plastic measuring 2 to 12 inches in height and 2 inches to 12 inches wide to accommodate different sizes of fruits and vegetables. It would consist of two-pieces with hinges on the upper, middle and lower back area that would enable the user to easily clamp the device around each developing fruit or vegetable attached to a plant, while it is in the early stage of growth. The device would have a stem opening made of soft rubber split in 2 halves and a protective foam cushion, also split in 2 halves, on one end that would allow it to be attached safely and securely over the stem without crushing it; this is known as the stem entry point. The plastic case would contain a plurality of ventilation apertures, which would provide proper ventilation and allow enough sunlight to penetrate through the plastic case to keep the produce healthy, while the device would form a barrier that would prevent animals, many forms of insects, or pests from consuming or damaging the produce (FIGS. 1, 2 and 4). After the produce reaches maturity and is removed from the plant for consumption, the device would be able to be reused by attaching it to another developing fruit or vegetable on the plant. Using the device would be beneficial to home gardeners or farmers who want to protect their crops naturally, without products that could be harmful to the plants, animals, people, or the environment.

The product could be produced using conventional and readily available materials and manufacturing processes. The device could be injection molded from clear plastic, such as Polyvinyl chloride (PVC). Polyvinyl chloride, polyvinyl butyrates, and polyvinylidene chloride are three of the most common of vinyl resins produced commercially. In addition to being especially suitable for surface coating and for flexible and rigid sheeting, they have excellent resistance to moisture and chemicals, including solvents. The stem entry can be made of flexible weather resistant rubber and the foam insert could be molded from polyurethane foam or foam rubber. The materials used should be weatherproofed for outdoor use to make it durable for many years. Of course, ultimately will be the manufacturer who makes the final decision regarding materials and processes most suitable for the manufacture of the device.

### DRAWINGS DESCRIPTIONS

FIG. 1 is an artistic illustration of the frontal view of the device invented for protection of growing fruits and vegetables

FIG. 2 is an artistic illustration of the posterior view of the device invented for protection of growing fruits and vegetables

FIG. 3. is an artistic illustration of the axial view of the entry point of the device invented for protection of growing fruits and vegetables

FIG. 4. is an artistic illustration of open device invented for protection of growing fruits and vegetables

### GENERAL DESCRIPTION OF ART

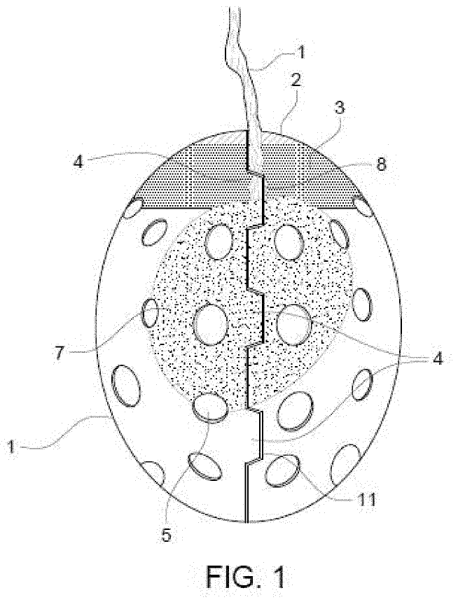

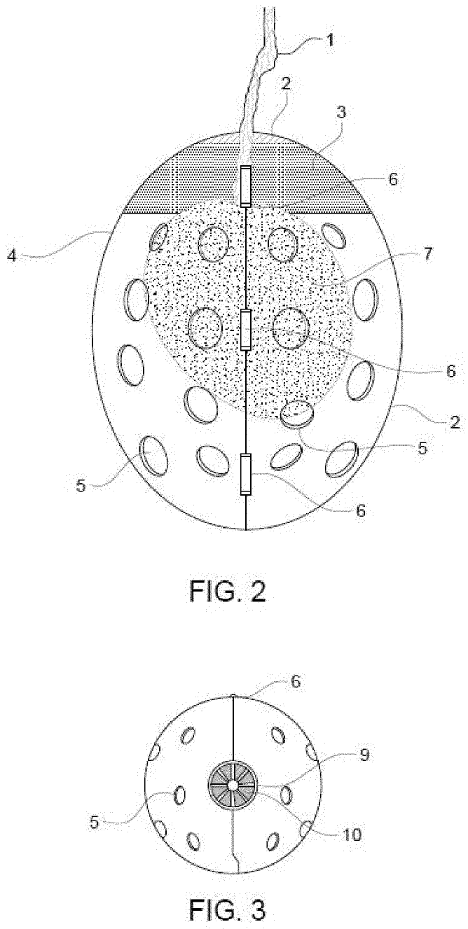

Referring to FIG. 1, basic component of the invented protection encasing system for protection of fruits and vegetables as viewed from the front, represents half of the encasing device made of clear or tinged light plastic (4), represents the other half of the encasing device made of clear or tinged light plastic (4), closed 9 (FIGS. 1, 2) attached to a fruit stem (1), stem entry, stem rubber opening/protector disk frontal view (2) stem entry point as viewed from the front, protective foam cushion as view from the front (3), clear plastic case as viewed from the front (4), a plurality of ventilation apertures in case as viewed from the front (5), illustration of fruit inside case as depicted from the front view (7), locking tongs (8). Referring to FIG. 2 basic component of the invented protection encasing system for protection of fruits and vegetables as viewed from the posterior, represents half of the encasing device made of clear or tinged light plastic, represents half of the encasing device made of clear or tinged light plastic, closed and attached to a fruit stem (1), stem entry point as viewed from the posterior, stem rubber opening/protector disk posterior view (2), inner protective foam cushion as viewed from the posterior (3), clear plastic case as view from the posterior (4), a plurality of ventilation apertures in encasing as viewed from the posterior (5), illustration of fruit inside encasing as depicted from the posterior view (7), upper, middle and lower hinges located on the posterior (6) of the device for protection of fruits and vegetables (FIG. 2)

Referring to FIG. 3 Axial view of the invented protection encasing system for protection of fruits and vegetables, stem rubber opening/protection disk (2), Stem Rubber Opening/Protection Disk Segmentation (9), Stem Entry Point, upper hinge as seen from axial view (6), Ventilation apertures (5).

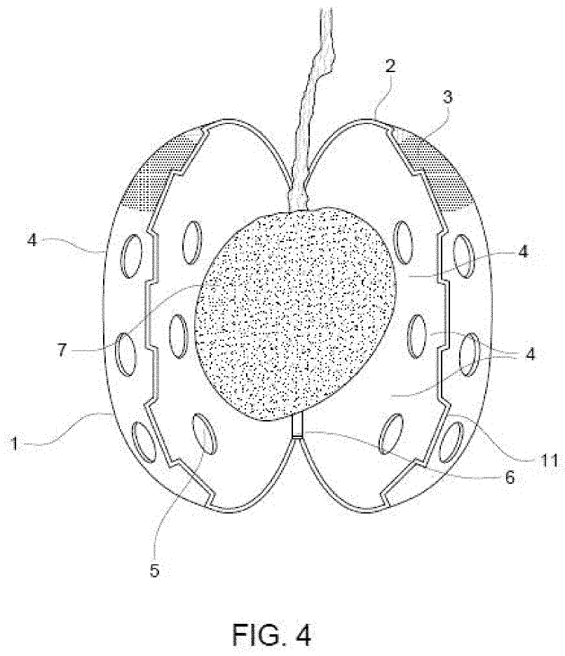

Referring to FIG. 4, basic component of the invented protection encasing system for protection of fruits and vegetables as viewed from open illustration, represents half of the encasing device made of clear or tinged light plastic (4), represents half of the encasing device made of clear or tinged light plastic (4), (FIG. 4) attached to a fruit stem (1) in the open position, stem rubber opening/protector disk frontal view with the device in the open view (2) stem entry point as viewed with the device in the open position, inner protective foam cushion as viewed from open position (3), clear plastic case as viewed from the open position (4), a plurality of ventilation apertures in case as viewed from the open position (5), illustration of fruit inside case as depicted from the open position (7), locking tong (8) as viewed from the open position, lower hinge as viewed from the open position (6).

The invented device is easy to attach to the plant. The device is held open until the fruit or vegetable requiring protection is within the volume of the sphere and the stem has reached the stem entry point. Applying the device over fruits or vegetables when they are beginning to develop would provide a reliable barrier that prevent animals, many insects or pests from consuming or damaging them. The spherical design would surround the fruit or vegetable without laying on them due to its unique foam cushion. Once the fruit or vegetable is secured inside, the spere is closed and locked into position and due to its light weight is held in position by the stem itself. The device can be re-opened, when necessary, by applying gentle pressure to the locking mechanism or it can be pulled down with the harvest produce.

The foregoing is considered as illustrative only of the principles of the invention. This device is designed to come in multiple sizes to accommodate fruits of a variety of sizes from 2 to 12 inches. Since many modifications and changes will readily occur to those skilled in the art, it is not desired to limit the invention to the exact construction and operation shown and described, and accordingly all suitable modifications and equivalents may be resorted to, falling within the scope of the invention as claimed.

The included substitute specification contains no new matter.

I claim:

1. A deterrent barrier for developing fruits and vegetables hanging from the plant against birds, rodents, squirrels, many insects and other pests comprising: a spherical structure which will be a deterrent to animals or insects: a light plastic case of variable capacity and volume; an upper end region, a middle region, a lower region, a front and rear regions; a plurality of apertures equidistant in the middle and lower region at least 1 millimeter in diameter; an upper region fitted with a segmented rubber disc with a central aperture, an internal upper region fitted with a circular piece of foam with an aperture in the middle, a set of 3 plastic hinges aligned equidistantly in the rear region: a system of locking grooves aligned equidistantly in the front region

2. The deterrent barrier for developing fruits and vegetables hanging from the plant against birds, rodents, squirrels, many insects and other pests of claim 1, wherein the said spherical structure form a protective shield, and wherein the walls of the said sphere are made of light plastic not thicker than approximately 2 millimeters.

3. The deterrent barrier for developing fruits and vegetables hanging from the plant against birds, rodents, squirrels, many insects and other pests of claim 1, wherein said sphere will have a variable internal volume to accommodate a large range of fully grown fruit or vegetable.

4. The deterrent barrier for developing fruits and vegetables hanging from the plant against birds, rodents, squirrels, many insects and other pests of claim 1, wherein said sphere will have a front side, a rear side, and lateral sides of the sane symmetry and length, and an upper end and lower end of the same diameter.

5. The deterrent barrier for developing fruits and vegetables hanging from the plant against birds, rodents, squirrels, many insects and other pests of claim 1, wherein the said sphere will contain 3 plastic hinges in the rear region confiding said sphere the property of opening and closing without losing form or volume.

6. The deterrent barrier for developing fruits and vegetables hanging from the plant against birds, rodents, squirrels, many insects and other pests of claim 1, wherein said sphere will contain series of locking grooves installed in the front region for secure and consistent locking while closed and unlocking when open.

7. The deterrent barrier for developing fruits and vegetables hanging from the plant against birds, rodents, squirrels, many insects and other pests of claim I, wherein a soft rubber segmented disk will be fit to said sphere at the upper end of the sphere with and aperture to allow easy passage of the fruit or vegetable stem and avoidance of stem damage during natural movement of the plant, said sphere or branch.

8. The deterrent barrier for developing fruits and vegetables hanging from the plant against birds, rodents, squirrels, many insects and other pests of claim 1, wherein the said sphere device is removable.

9. The deterrent barrier for developing fruits and vegetables hanging from the plant against birds, rodents, squirrels, many insects and other pests of claim 1, wherein said sphere will require installation to each fruit or vegetables requiring protection.

10. The deterrent barrier for developing fruits and vegetables hanging from the plant against birds, rodents, squirrels, many insects and other pests of claim 1, wherein said sphere consists of a light plastic material.

11. The deterrent barrier for developing fruits and vegetables hanging from the plant against birds, rodents, squirrels, many insects and other pests of claim 1, wherein said sphere may be clear or tinge of multiple colors.

12. The deterrent barrier for developing fruits and vegetables hanging from the plant against birds, rodents, squirrels, many insects and other pests of claim 1, wherein said sphere may have residential or commercial applications.

13. The deterrent barrier for developing fruits and vegetables hanging from the plant against birds, rodents, squirrels, insects and many insects and other pests claim 1, wherein said sphere is a reusable device.

14. The deterrent barrier for developing fruits and vegetables hanging from the plant against birds, rodents, squirrels, many insects and other pests of claim 1, wherein said sphere is environmentally friendly since said sphere does not lead to use of harmful methods to animals or pollinating insects or animals.
The included substitute specification contains no new matter.
